(19) United States
(12) Patent Application Publication
(10) Pub. No.: US 2017/0306275 A1
(43) Pub. Date: Oct. 26, 2017

(54) AUTOMATED MALT PRODUCTION SYSTEM

(71) Applicant: Integrated Process Engineers & Constructors, Inc., Fort Atkinson, WI (US)

(72) Inventors: Adam Paul, Fort Atkinson, WI (US); Mark McGlynn, Fort Atkinson, WI (US)

(73) Assignee: Integrated Process Engineers & Constructors, Inc., Fort Atkinson, WI (US)

(21) Appl. No.: 15/489,171

(22) Filed: Apr. 17, 2017

Related U.S. Application Data
(60) Provisional application No. 62/325,688, filed on Apr. 21, 2016.

(51) Int. Cl. C12C 1/15; C12C 13/00; C12C 1/16

(52) U.S. Cl. CPC C12C 1/15; C12C 1/16; C12C 13/00

(57) ABSTRACT

An automated malt production system features a processing vessel for carrying out all steps of the malting process, including steeping, germinating, and kilning. An agitator in the processing vessel utilizes an integral auger to turn the grain during processing. Sweeps mounted to the agitator move grain towards or away from the auger, depending on the direction of rotation of the agitator, breaking up the mass of grain to allow aeration and prevent binding. A support skid carries multiple mounted system elements, such as a process air blower or heater, allowing them to be easily shipped and connected to the processing vessel.

### CROSS-REFERENCE TO RELATED APPLICATIONS

The present application claims priority of U.S. Provisional Patent Application No. 62/325,688, filed on Apr. 21, 2016, the contents of which are incorporated herein by reference in their entirety.

### FIELD OF THE INVENTION

The present invention is directed to an apparatus for preparing malt, and particularly to an “all-in-one” apparatus capable of steeping, germinating, kilning, and turning grain during the malting process.

### BACKGROUND OF THE INVENTION

Malted grain is used by a wide variety of food and beverage industries, particularly the beer brewing and spirit distilling industries. During the malting process, a batch of grain is periodically soaked in water (steeped) and allowed to dry. Once the grain has achieved a target moisture content, it sprouts (germinates), which allows for conversion of starch to sugar (modification) and development of malt enzymes. During germination, grain is periodically turned to keep it from growing together (felting) and blocking air flow. After sufficient modification and enzyme development, the grain is dried and heated (kilned) to stop germination, break down unwanted chemical compounds, and develop desired malt color.

Traditional malting processes germinate the grain over the surface of a floor, where workers rake and turn the grain. This requires intensive manual labor and large open spaces to perform the malting process. Automated malting processes have attempted, with some success, to reduce the labor and space required to malt grain, but still require multiple pieces of interconnected equipment to accomplish the various steps of steeping, germinating, kilning, and turning grain during the process.

There is an unmet need in the art for a single apparatus capable of performing all steps of a controlled malting process within a relatively small footprint.

### BRIEF SUMMARY OF THE INVENTION

An exemplary embodiment of the present invention is an agitator apparatus including an auger extending around a main shaft from a first upper point on the main shaft to a second lower point on the main shaft. At least two sweeps extend orthogonally from the main shaft from a third point below the second lower point and from a fourth point below the second lower point. Each of the at least two sweeps has a substantially triangular cross section formed by a sweep vertical surface, a sweep upper surface, and a sweep lower surface. The sweep vertical surface is flat in a vertical cross section. The sweep vertical surface is located opposite a sweep tapered edge formed by the sweep upper surface and the sweep lower surface.

Another exemplary embodiment of the present invention is a processing vessel apparatus including the above-referenced agitator. The processing vessel also includes a malting chamber made up of a sidewall located between an upper head and a lower head. The upper head has a convex configuration and includes a process air outlet and an agitator motor connected to the main shaft of the agitator apparatus. The main shaft extends through the upper head. The malting chamber includes a chamber spray device, at least one lower manway, and a grate located directly above the lower head. The grate is level with a lower edge of the at least one lower manway. The lower head includes a sloping plenum chamber located directly below the grate, a drainage port, an aeration device, and a spray manifold. The drainage port is located at the lowest point of the sloping plenum chamber.

Another exemplary embodiment of the present invention is an automated malt production system including the above-referenced agitator and processing vessel. The system also includes a support skid having a process air blower, a heater, a cooling exchanger, a humidifying chamber and a control panel mounted to a skid frame. The process air blower is connected to the heater. The heater is connected to the cooling exchanger. The cooling exchanger is also connected to the humidifying chamber, leading to the processing vessel. The control panel includes a controller, an operator interface, and a plurality of motor control units connected to the agitator motor, the process air blower, and the heater.

The objects and advantages of the invention will appear more fully from the following detailed description of the preferred embodiment of the invention made in conjunction with the accompanying drawings.

### BRIEF DESCRIPTION OF THE SEVERAL VIEWS OF THE DRAWINGS

FIGS. 1a and 1b illustrate side cross-sectional and perspective views, respectively, of an exemplary embodiment of a processing vessel.

FIGS. 1c and 1d illustrate perspective and side cross-sectional views, respectively, of an exemplary embodiment of the processing vessel with an agitator.

FIGS. 2a, 2b, and 2c illustrate side, top, and perspective views, respectively, of an exemplary embodiment of the agitator.

FIG. 3 illustrates a perspective view of an exemplary embodiment of an automated malt production system.

### DETAILED DESCRIPTION OF THE INVENTION

System 100 includes at least one processing vessel 200, at least one agitator 300 located in the at least one processing vessel 200, and at least one support skid 400 connected to the at least one processing vessel 200. Certain embodiments of system 100 may include multiple processing vessels 200, each having its own agitator 300. Each processing vessel 200 also has its own support skid 400.

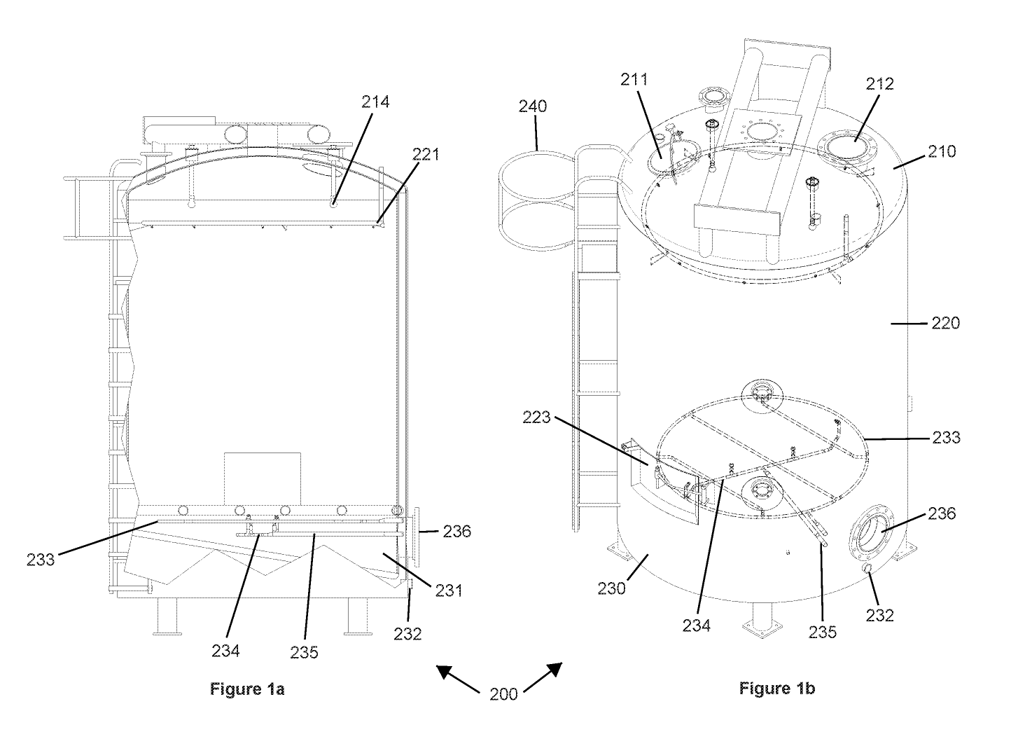

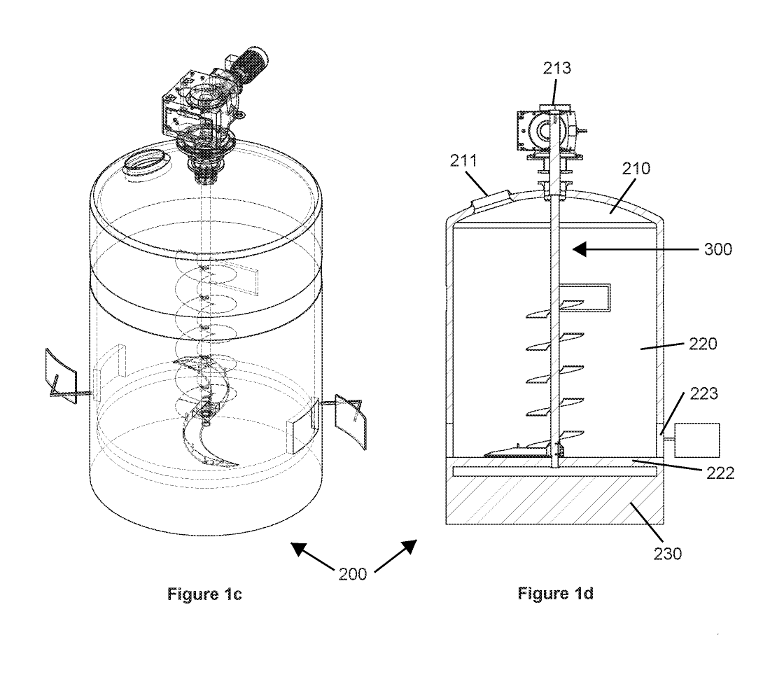

FIGS. 1a and 1b illustrate perspective and side cross-sectional views, respectively, of an exemplary embodiment of processing vessel 200, while FIGS. 1c and 1d illustrate perspective and side cross-sectional views, respectively, of an exemplary embodiment of processing vessel 200 with an agitator 300. Processing vessel 200 includes an upper head 210, a lower head 230, and a malting chamber 220 located therebetween. In the exemplary embodiment, a ladder 240 is mounted to the outside of processing vessel 200 to allow full access to all portions of upper head 210, malting chamber 220, and lower head 230. In the exemplary embodiment, accessibility to all levels of processing vessel 200 requires ladder 240 because processing vessel 200 is a vertical vessel with a multi-ton grain batch processing capability. Other embodiments with significantly smaller grain batch processing capability may not require ladder 240. Processing vessel 200 is fully insulated to prevent unwanted heat loss or injury to workers.

Upper head 210 is a convex cap integral to processing vessel 200. At least one upper manway 211 in upper head 210 allows workers access to the inside of processing vessel 200 for cleaning, sampling, maintenance, and inspection. At least one grain inlet in upper head 210 permits passage of grain into processing vessel 200. At least one process air outlet 212 allows exhaustion of gasses from processing vessel 200 to allow oxygen flow through the grain bed during steeping, removal of carbon dioxide produced by grain during steeping, process air flow through the grain bed at a constant temperature and humidity during germination, and tempered process air flow through the grain bed during kilning. To increase efficiency and reduce costs, process air outlet 212 may also connect back to processing vessel 200 to allow recycling of tempered process air, or a regenerative heat exchanger 470 to allow for recovery of process air energy.

An agitator motor 213 on upper head 210 connects to agitator 300 within processing vessel 200 to rotate agitator 300 in processing vessel 200. Agitator motor 213 allows agitator 300 to turn through large masses of grain at low speeds, reducing potential damage to grain during processing. At least one upper head spray device 214 in upper head 210 emits water to fill processing vessel 200 during steeping. In the exemplary embodiment, upper head spray device 214 is a spray ball. Upper head spray device 214 also emits water, detergent, or other fluids for cleaning the interior surfaces of processing vessel 200 after completion of the malting process. A separate cleaning-in-place (CIP) unit can supply cleaning materials.

Malting chamber 220 is a cylindrical chamber with a sidewall extending between upper head 210 and lower head 230. At least one chamber spray device 221 located at an upper level of malting chamber 220 emits a substantially even distribution of water across the grain bed during germination and other steps in the malting process. In the exemplary embodiment, chamber spray device 221 is a spray ring. Chamber spray device 221 also emits water, detergent, or other fluids for cleaning the interior surfaces of processing vessel 200 after completion of the malting process. A grate 222 located at a lower level of malting chamber 220 supports the grain, preventing it from falling into lower head 230 while still allowing water drainage. In the exemplary embodiment, grate 222 is a wedge wire screen, i.e. a wire screen where the wires extending in at least one direction have a cross-section that tapers in a downward direction. In certain embodiments, grate 222 is made of multiple separate sections, allowing it to be removed from processing vessel 200 for cleaning, replacement, and maintenance.

While the exemplary embodiment includes lower manways 223, other embodiments may include more or fewer lower manways 223. Lower manways 223 are located on the sidewall of malting chamber 220. Lower manways 223 are curved to match the diameter of processing vessel 200 and seal flush with the sidewall of malting chamber 220 to eliminate dead space or pockets for grain to become trapped during the malting process. The lower edges of lower manways 223 are flush with the upper surface of grate 222. As a result, when lower manways 223 open after completion of the malting process, malted grain flows freely from malting chamber 220 in response to movement of agitator 300. Lower manways 223 also provide access for removing grate 222 and for cleaning processing vessel 200.

Sight portals 224 may also be located in the sidewall of malting chamber 220 to allow workers to visually monitor the progress of the malting process. Because the color of a malted grain is linked to its flavor, and the flavor it provides as a component of foods and beverages, workers may wish to ensure visually that a batch of malted grain has an appropriate shade. As with lower manways 223, sight portals 224 are set flush with the sidewall of malting chamber 220 to prevent grain from becoming trapped during the malting process. Sight portals 224 may be located at multiple levels and/or locations about the circumference of malting chamber 220.

Lower head 230 is an angled cap integral to processing vessel 200. The interior of lower head 230 forms a sloped plenum chamber 231. Plenum chamber 231 allows even distribution of process air during the process, and for drainage of water during and after steeping, germination, and cleaning. The slope in plenum chamber 231 causes water to collect at the bottommost point of plenum chamber 232. A drainage port 232 located at the bottommost point of plenum chamber 232 drains water from plenum chamber 231.

Aeration device 233 is located under grate 222 in plenum chamber 231. In the exemplary embodiment, aeration device 233 is an aeration ring. Aeration device 233 is connected to supplies of water and compressed air. During steeping, aeration device 233 aerates the water using the compressed air. Aeration device 233 may also emit water, detergent, or other fluids for cleaning the interior surfaces of processing vessel 200 after completion of the malting process. Likewise, a lower head spray device 234 connected to a spray manifold 235 located in plenum chamber 231 can clean the undersides of grate 222 or agitator 300 after completion of the malting process.

Any of the above-mentioned ports, inlets, or outlets may be fitted with valves or adjustable closures to control flow into or out of processing vessel 200.

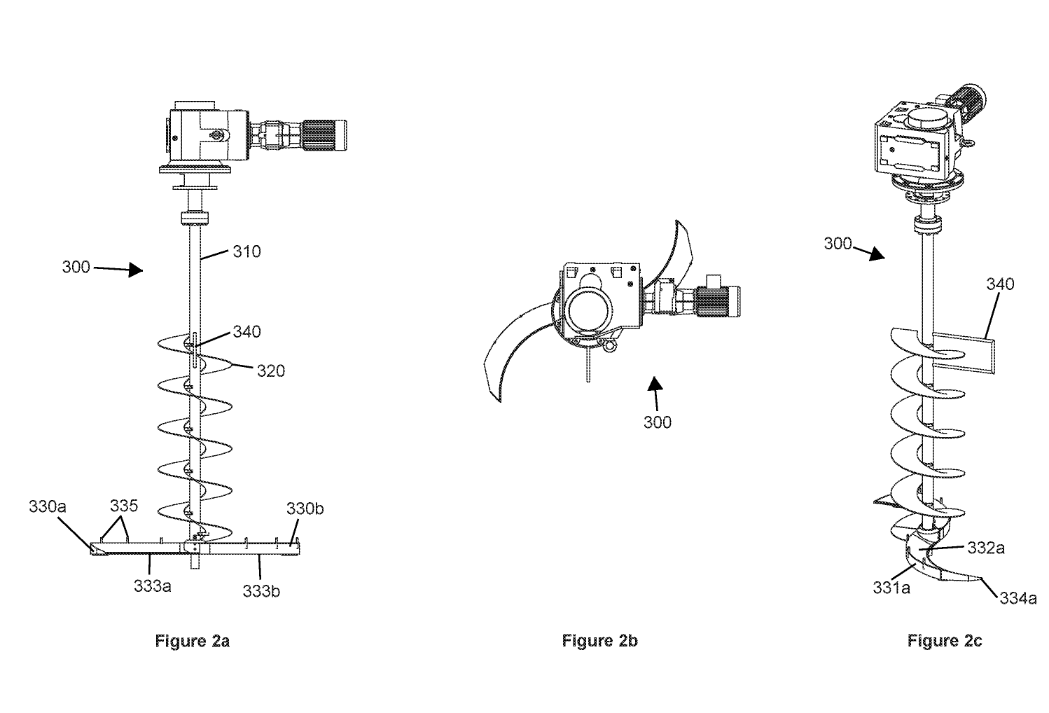

FIGS. 2a, 2b, and 2c illustrate side, top, and perspective views, respectively, of an exemplary embodiment of agitator 300. In the exemplary embodiment, agitator 300 is made up of a main shaft 310 connected to an auger 320, sweeps 330 extending orthogonally from main shaft 310, and a leveler bar 340 extending from main shaft 310. Depending on the pitch of auger 320, rotation of main shaft 310 in a first direction clockwise or counterclockwise causes grain to travel up main shaft 310 and auger 320. Rotation of main shaft 310 in a second direction opposite the first direction causes grain to travel down main shaft 310 and auger 320. For purposes of the exemplary embodiment and by way of non-limiting description, it shall be assumed that counterclockwise rotation causes upward grain movement and that clockwise rotation causes downward grain movement. Other embodiments, however, may feature opposite orientations of rotation for upward and downward grain movement. Agitator 300 may be a single piece or an assembly of multiple pieces.

The flight of auger 320 is less than the length of main shaft 310 to accommodate connection of main shaft 310 to a drive unit and sweeps 330. In the exemplary embodiment, auger 320 is a single flight ribbon auger with a half pitch of thirteen inches. In the exemplary embodiment, a bottom edge of auger 320 is attached to one of sweeps 330, with spaces between multiple attachment points connecting main shaft 310 and the inner edge of auger 320. In other embodiments, auger 320 may be a single flight auger, may have a standard pitch, and/or may have a pitch ranging from approximately six inches to approximately twenty-four inches. In other embodiments, auger 320 may attach to main shaft 310 all along its inner edge.

While the exemplary embodiment includes two sweeps 330, other embodiments may include more or fewer sweeps 330. Each of sweeps 330 has a sweep vertical surface 331 connecting a first side of sweep upper surface 332 to a first side of sweep lower surface 333. Sweep vertical surfaces 331 are flat (i.e. not curved) in a vertical cross-section. Each of the angled sweep upper surfaces 332 also connects directly to one of the horizontal sweep lower surfaces 333 to form sweep tapered edges 334 on a second side of sweep upper surface 332 and a second side of sweep lower surface 333.

In the exemplary embodiment, the second side of sweep upper surface 332 forms an angle of approximately twenty-eight degrees with sweep lower surface 333. In other embodiments, sweep upper surface 332 may form angles ranging from approximately ten degrees to approximately forty-five degrees with sweep lower surface 333. As a result, sweeps 330 have a substantially right triangular cross-section. In certain embodiments, sweep upper surface 332 may form multiple different angles with sweep lower surface 333. Sweep lower surface 333 is raised above grate 222 such that grain cannot be sheared or crushed between sweep lower surface 333 and grate 222.

In the exemplary embodiment, each sweep 330 also has a plurality of sweep protrusions 335 extending from sweep upper surface 332. In the exemplary embodiment, sweep protrusions 335 are vertical pegs extending orthogonally from sweep upper surface 332. In other embodiments, sweep protrusions 335 may be angled ridges formed in parallel and extending from the first sides to second sides of sweep upper surface 332. In the exemplary embodiment, sweep protrusions 335 are offset from each other on different sweep upper surfaces 332. Sweep protrusions 335 may act to break up the mass of grain and direct it toward or away from auger 320.

Rotation of main shaft 310 also causes movement of sweeps 330. During counterclockwise rotation, sweep tapered edge 334 moves under the grain, scooping it up and towards auger 320. During clockwise rotation, sweep vertical surface 331 pushes grain away from auger 320 and, if lower manways 223 are open, out at least one of lower manways 223, unloading processing vessel 200 upon completion of the malting process.

In the exemplary embodiment, each sweep tapered edge 334 and sweep vertical surface 331 curves in a horizontal cross-section as they extend from main shaft 310. Sweeps 330 are curved such that during clockwise rotation the stationary points of the curves of sweep vertical surfaces 331 lead, and during counterclockwise rotation the stationary points of the curves of sweep vertical surfaces 331 trail, enhancing movement of grain away from or toward auger 320, respectively. Sweep vertical surfaces 331 may have a radius of approximately twenty-four inches to approximately forty inches. Sweep tapered edges 334 may have a radius of approximately twenty inches to approximately thirty inches. In other embodiments, sweep tapered edges 334 and/or sweep vertical surfaces 331 may be straight.

When grain rises up auger 320, it can rise too high. As main shaft 310 rotates, an attached leveler bar 340 pushes grain away at a predetermined height, causing the grain to spill down and mix with grain at a lower level. In the exemplary embodiment, an upper edge of leveler bar 340 is level with an upper edge of auger 320, while a lower edge of leveler bar 420 is located a half pitch below the upper edge. In the exemplary embodiment, leveler bar 340 has a substantially rectangular shape. In other embodiments, leveler bar 340 may have a substantially linear, triangular, square, or paddle shape.

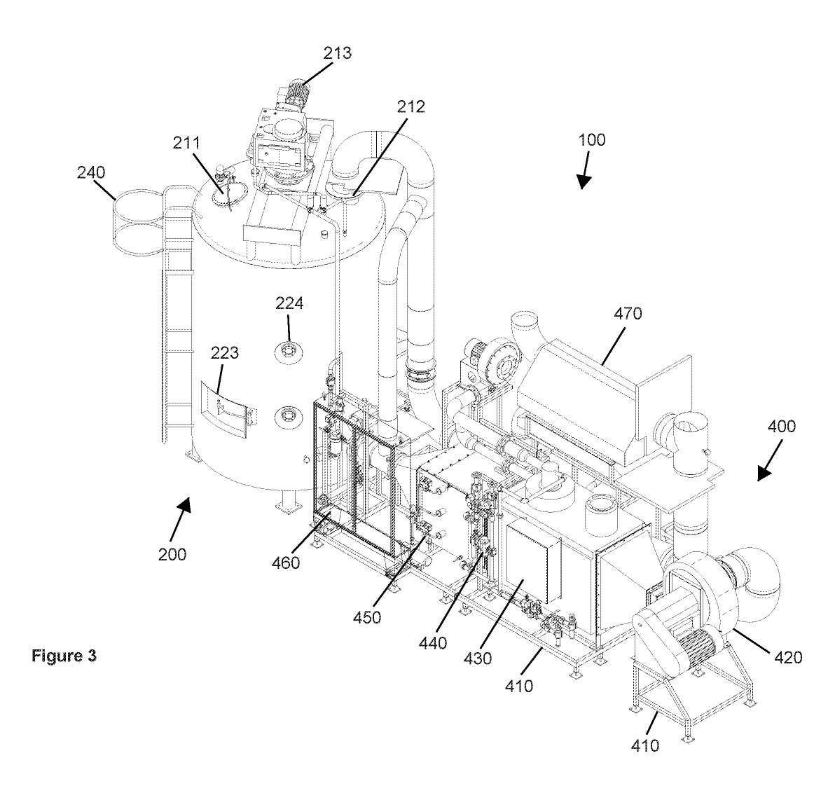

FIG. 3 illustrates a perspective view of an exemplary embodiment of automated malt production system 100. The various components of support skid 400, such as at least one process air blower 420, at least one heater 430, at least one cooling exchanger 440, at least one humidifying chamber 450, and at least one control panel 460 are mounted on a skid frame 410. Skid frame 410 allows the entire support skid 400 and components to be shipped to a purchaser, reducing the amount of time required to assemble, install, and connect support skid 400 and processing vessel 200. In certain embodiments, skid frame 410 may be divided into multiple parts for easier shipping and installation. In such embodiments, the various components of support skid 400 may be mounted to different parts of skid frame 410.

Process air blower 420 is connected to heater 430 and provides process air flow during the malting process. Heater 430 heats process air as needed during the malting process and is connected to cooling exchanger 440. Heater 430 may be a gas furnace, a heat exchanger, or at least one electric heating element. Cooling exchanger 440 cools process air as needed during the malting process and is connected to humidifying chamber 450. Cooling exchanger 440 may utilize water, brine, glycol, thermal oil, or any other thermal media or combination of thermal media known in the art. Humidifying chamber 450 humidifies process air as needed during the malting process, particularly during germination or during production of specialty malts, and is connected to process air inlet 236. Spray nozzles in humidifying chamber 450 spray atomized water, pressurized above the level found in water mains by a booster pump, through process air as the process air moves through humidifying chamber 450.

Control panel 460 includes a controller 461 connected to an operator interface 462, motor control units 463, and sensors 464. In the exemplary embodiment, controller 461 is a programmable logic controller. In other embodiments, controller 461 may be a remote telemetry unit, PID controllers, switchgears, an Ethernet-based industrial network, a personal computer or laptop, or any other type of controller known in the art. Controller 461 may include storage media for storing predetermined malting “programs.” Each program includes time and timing parameters, agitation parameters, temperature parameters, water flow parameters, air flow parameters, humidity parameters, and/or any other processing parameters necessary for the steps of steeping, germinating, kilning, and turning grain during the malting process. Each program may create a different batch of malt, such as, by way of non-limiting example, pilsner, pale, mild, amber, brown, crystal, distiller's, Vienna, Munich, or any other type of malt possible using forced air kilning at up to 350 degrees Fahrenheit. Other programs may cause cleaning or sterilization of various elements of processing vessel 200, agitator 300, or support skid 400. Again, the parameters of these programs may be stored in storage media. Programs may be preprogrammed into controller 461 or added to controller 461 by a user. Programs may be reconfigurable by users or permanently configured.

Examples of storage media include random access memory, read only memory, magnetic discs, optical discs, flash memory, virtual memory, and non-virtual memory, magnetic sets, magnetic tape, magnetic disc storage or other magnetic storage devices, or any other medium which can be used to storage the desired information and that may be accessed by an instruction execution system, as well as any combination or variation thereof, or any other type of storage medium. In certain embodiments, the storage media may be a non-transitory storage media. In certain embodiments, at least a portion of the storage media may be transitory.

Operator interface 462 may include a mouse, a keyboard, a voice input device, a touch input device for receiving a gesture from an operator, a motion input device for detecting non-touch gestures and other motions by an operator, and other comparable input devices and associated processing elements capable of receiving input from an operator. Output devices such as a video display or graphical display can display an interface further associated with certain embodiments as disclosed herein. Printers, haptic devices and other types of output devices may also be included in operator interface 462. In the exemplary embodiment, operator interface 462 is a touchscreen with a graphical user interface.

Motor control units 463 are connected to upper manway 211, agitator motor 213, lower manways 223, process air blower 420, heater 430, cooling exchanger 440, and humidifying chamber 450, as well as any valves or adjustable closures, to allow controlled actuation of these elements. Motor control units 463 also include safety interlocks that prevent operation of any of the above elements in potentially dangerous situations. By way of non-limiting example, the safety interlock of a motor control unit 463 connected to a lower manway 223 may prevent lower manway 223 from opening during kilning to prevent injury to any workers near processing vessel 200. Sensors 464 may be placed to communicate between control panel 460 and any part of processing vessel 200, agitator 300, or support skid 400. Sensors 464 may measure temperature, pressure, process air flow, liquid flow, liquid level, humidity, carbon dioxide levels, dissolved oxygen levels, or any other measurable quantity that could affect safety or malt production.

Certain embodiments of control panel 460 may also include a router 465. Router 465 provides access to control panel 460 via a web-based interface, allowing monitoring and adjustment of the malting process from anywhere in the world on a computer or mobile device. Router 465 may also transmit email or text message alerts for notification of critical system alarms, such as, by way of non-limiting example, a very high temperature detected in malting chamber 220 by sensors 464.

The exemplary embodiment also incorporates an optional regenerative heat exchanger 470 as part of support skid 400. Regenerative heat exchanger 470 receives waste process air from processing vessel 200 prior to waste process air discharge from system 100. Before the waste process air discharges, regenerative heat exchanger 470 transfers heat from the waste process air to fresh process air entering system 100, thereby increasing energy efficiency and decreasing the amount of heat discharged into the environment.

During steeping, the grain is alternately soaked in water (wet steep) by upper head spray device 214 and drained (air rest) through drainage port 232. Grate 222 keeps the grain from draining out as well. The grain is aerated during the wet steep through aeration device 233 located in plenum chamber 231. Process air is blown through the grain bed during air rest by aeration device 233 to remove CO2 and heat produced by grain respiration through process air outlet 212. Optionally, the wet steep may be preceded by rinsing the grain to remove dirt, dust, and other debris.

During germination, temperature-controlled humidified process air is blown through the grain bed through aeration device 233 and water is periodically added through chamber spray device 221. This process continues the sprouting, modifying the grain, and producing the enzymes for the end-use. The grain is periodically mixed by agitator 300 during the germination phase to promote process air flow and to prevent rootlets from binding the grain into a solid mass.

During kilning, the grain is progressively dried, then cured using heated process air passed through aeration device 233. Upon completion of curing, the grain is cooled using cooled or ambient-temperature process air passed through aeration device 233. Once cool, the grain is unloaded through at least one of lower manways 223 using agitator 300.

During processing (steeping, germinating, kilning), agitator 300 is operated in the forward (counterclockwise) direction. Sweeps 330 draw the grain towards auger 320 using sweep tapered edges 334 and/or sweep protrusions 335. Sweeps 330 draw the grain gently inward without damaging forming rootlets or trapping grain between sweeps 330 and grate 222. Grain that is not drawn into auger 320 rides over sweep upper surfaces 332 and falls back onto the upper surface of grate 222, or passes under sweep lower surfaces 333 to remain on grate 222. Grain that is drawn into auger 320 is carried up through malting chamber 220.

As grain reaches the top of malting chamber 220 it may fall, as a result of gravity, out toward the sidewall of malting chamber 220. Any grain that continues to move upward on top of auger 320 will be mechanically pushed out and down via leveler bar 340. The entirety of agitator 300 is preferably configured to be low-shear, to both reduce potential damage to grain during processing and to reduce torque and horsepower requirements for agitator motor 213.

After the process is complete, agitator 300 is operated in the reverse (clockwise) direction to unload the grain through at least one of lower manways 223 on the sidewall at the level of grate 222. Auger 320 promotes downward movement of the grain, and sweeps 330 push the grain out towards lower manways 223 using sweep vertical surfaces 331.

Any version of any component or method step of the invention may be used with any other component or method step of the invention. The elements described herein can be used in any combination whether explicitly described or not.

As used herein, the singular forms “a,” “an,” and “the” include plural referents unless the content clearly dictates otherwise. Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All patents, patent publications, patent applications, and peer-reviewed publications (i.e., “references”) cited herein are expressly incorporated by reference in their entirety to the same extent as if each individual reference were specifically and individually indicated as being incorporated by reference. In case of conflict between the present disclosure and the incorporated references, the present disclosure controls.

The devices, methods, compounds and compositions of the present invention can comprise, consist of, or consist essentially of the essential elements and limitations described herein, as well as any additional or optional steps, ingredients, components, or limitations described herein or otherwise useful in the art.

While this invention may be embodied in many forms, what is described in detail herein is a specific preferred embodiment of the invention. The present disclosure is an exemplification of the principles of the invention is not intended to limit the invention to the particular embodiments illustrated. It is to be understood that this invention is not limited to the particular examples, process steps, and materials disclosed herein as such examples, process steps, and materials may vary somewhat. It is also understood that the terminology used herein is used for the purpose of describing particular embodiments only and is not intended to be limiting since the scope of the present invention will be limited to only the appended claims and equivalents thereof.

What is claimed is:

1. An agitator apparatus comprising:
an auger extending around a main shaft from a first upper point on the main shaft to a second lower point on the main shaft;
at least two sweeps extending orthogonally from the main shaft from a third point below the second lower point and from a fourth point below the second lower point,
wherein each of the at least two sweeps has a substantially triangular cross section formed by a sweep vertical surface, a sweep upper surface, and a sweep lower surface,
wherein the sweep vertical surface is flat in a vertical cross section,
wherein the sweep vertical surface is located opposite a sweep tapered edge formed by the sweep upper surface and the sweep lower surface.

2. The agitator apparatus of claim 1, wherein the auger is a ribbon-type auger.

3. The agitator apparatus of claim 1, wherein the auger has a pitch ranging from approximately six inches to approximately twenty-four inches.

4. The agitator apparatus of claim 1, wherein each of the at least two sweeps has a substantially right triangular cross section.

5. The agitator apparatus of claim 1, wherein each of the sweep upper surfaces forms an angle of approximately twenty-eight degrees with one of the sweep lower surfaces at the sweep tapered edge.

6. The agitator apparatus of claim 1, wherein each of the sweep upper surfaces forms an angle ranging from approximately ten degrees to approximately forty-five degrees with one of the sweep lower surfaces at the sweep tapered edge.

7. The agitator apparatus of claim 1, wherein at least one of the sweep vertical surface or sweep tapered edge curves in a horizontal cross-section as the at least two sweeps extend from the main shaft.

8. The agitator apparatus of claim 1, further comprising a leveler bar extending orthogonally from the main shaft at or at least partially below the first upper point.

9. The agitator apparatus of claim 1, further comprising a plurality of sweep protrusions extending from each sweep upper surface.

10. The agitator apparatus of claim 9, wherein the plurality of sweep protrusions are pegs extending substantially parallel to the main shaft.

11. The agitator apparatus of claim 9, wherein the plurality of sweep protrusions are ridges extending substantially parallel to each other on each sweep upper surface.

12. A processing vessel apparatus comprising:
an agitator apparatus comprising:
an auger extending around a main shaft from a first upper point on the main shaft to a second lower point on the main shaft,
at least two sweeps extending orthogonally from the main shaft from a third point below the second lower point and from a fourth point below the second lower point,
wherein each of the at least two sweeps has a substantially triangular cross section formed by a sweep vertical surface, a sweep upper surface, and a sweep lower surface,
wherein the sweep vertical surface is flat in a vertical cross section,
wherein the sweep vertical surface is located opposite a sweep tapered edge formed by the sweep upper surface and the sweep lower surface;
a malting chamber comprising a sidewall located between an upper head and a lower head;
the upper head having a convex configuration and including a process air outlet and an agitator motor connected to the main shaft of the agitator apparatus, wherein the main shaft extends through the upper head;
the malting chamber including a chamber spray device, at least one lower manway, and a grate located directly above the lower head, wherein the grate is level with a lower edge of the at least one lower manway; and
the lower head including a sloping plenum chamber located directly below the grate, a drainage port, an aeration device, and a spray manifold connected to a lower head spray device, wherein the drainage port is located at the lowest point of the sloping plenum chamber.

13. The processing vessel apparatus of claim 12, wherein the grate is made of multiple separate sections.

14. The processing vessel apparatus of claim 12, wherein the grate is a wedge wire screen.

15. The processing vessel apparatus of claim 12, further comprising at least one upper manway in the upper head.

16. The processing vessel apparatus of claim 12, further comprising at least one sight portal in the malting chamber.

17. An automated malt production system comprising:
an agitator apparatus comprising:
an auger extending around a main shaft from a first upper point on the main shaft to a second lower point on the main shaft,
at least two sweeps extending orthogonally from the main shaft from a third point below the second lower point and from a fourth point below the second lower point,
wherein each of the at least two sweeps has a substantially triangular cross section formed by a sweep vertical surface, a sweep upper surface, and a sweep lower surface,
wherein the sweep vertical surface is flat in a vertical cross section,
wherein the sweep vertical surface is located opposite a sweep tapered edge formed by the sweep upper surface and the sweep lower surface;
a processing vessel apparatus comprising:
a malting chamber comprising a sidewall located between an upper head and a lower head,
the upper head having a convex configuration and including a process air outlet and an agitator motor connected to the main shaft of the agitator apparatus, wherein the main shaft extends through the upper head,
the malting chamber including a chamber spray device, at least one lower manway, and a grate located directly above the lower head, wherein the grate is level with a lower edge of the at least one lower manway, and
the lower head including a sloping plenum chamber located directly below the grate, a drainage port, an aeration device, and a spray manifold connected to a lower head spray device, wherein the drainage port is located at the lowest point of the sloping plenum chamber; and
a support skid comprising:
a process air blower connected to a heater,
the heater connected to a cooling exchanger,
the cooling exchanger connected to a humidifying chamber,
the humidifying chamber connected to the sloping plenum chamber,
a control panel having a controller, an operator interface, and a plurality of motor control units connected to the agitator motor, the process air blower, and the heater,
wherein the process air blower, the heater, the cooling exchanger, the humidifying chamber and the control panel are mounted to a skid frame.

18. The system of claim 17, wherein the controller is selected from the group consisting of: a programmable logic controller, a remote telemetry unit, PID controllers, switchgears, an Ethernet-based industrial network, a personal computer, and a laptop.

19. The system of claim 17, wherein the heater is selected from the group consisting of: a gas furnace, a heat exchanger, or at least one electric heating element.

20. The system of claim 17, further comprising a regenerative heat exchanger connected to the process air outlet.
